(19) United States
(12) Patent Application Publication
(10) Pub. No.: US 2004/0164990 A1
(43) Pub. Date: Aug. 26, 2004

(54) Method, controller and apparatus for displaying BIOS debug message

(76) Inventors: Yi-Hsin Chan, Taipei (TW); Ming-Hsiang Chou, Taipei (TW)

Correspondence Address: CHARLES C.H. WU & ASSOCIATES, Suite 710, 7700 IRVINE CENTER DRIVE, IRVINE, CA, 92618-3043, US

(21) Appl. No.: 10/428,432

(22) Filed: May 2, 2003

(30) Foreign Application Priority Data
Feb. 20, 2003 (TW) 92103487

(51) Int. Cl. G09G 5/00

(52) U.S. Cl. 345/581

(57) ABSTRACT

A method, controller and apparatus for displaying BIOS debug message is disclosed. The method determines a display style for a character code output from a debug port of BIOS according to an attribute code output from the debug port. Moreover, the controller accepts the character code and the attribute code and determines the display style of the character code according to the attribute code. Furthermore, the apparatus drives a display panel to display the character code according to the display style determined by the controller.

### CROSS-REFERENCE TO RELATED APPLICATION

This application claims the priority benefit of Taiwan application serial no. 92103487, filed Feb. 20, 2003.

### BACKGROUNDING OF THE INVENTION

1. Field of Invention

The present invention generally relates to a method for displaying BIOS debug message, and more particularly, to a method, controller and apparatus for displaying the information transmitted via a PC debug port in versatile information styles.

2. Description of Related Art

The conventional PC debug port display panel only displays the BIOS (Basic Input Output System) debug code output, and the debug code is input via an I/O port (e.g. port 80) and output to the display panel after passing through a built-in decoder inside the display panel. Accordingly, displaying the debug code via the PC debug port interface in the BIOS execution process is a quite simple method, and the PC debug port interface is supported by almost all mainboard chipsets. However, the conventional style for displaying the debug code via the PC debug port has many limitations and disadvantages. For example, it can only display one single byte debug code information at a time, it cannot describe the type and reason for the error, it cannot display related figures (e.g. microprocessor temperature, operating voltage, fan speed, . . . etc), it cannot present a special alert visual effect (e.g. flashing, hi-lighting), and it cannot display the error message in Chinese/English character string.

FIG. 1A and FIG. 1B schematically show a structure block diagram of a conventional debug code display apparatus and a conventional debug code displaying flow chart. After the input debug code of the BIOS 11 is displayed, the debug code is stored in a latch circuit 122 (step 13). The debug code stored in the latch circuit 122 is input into a decoder 123 for decoding (step 14). The debug code is displayed on a LED 7-segment display unit 124 (step 15). It continuously detects whether there is a new debug code input or not (step 16).

### SUMMARY OF THE INVENTION

To solve the problem mentioned above, the present invention provides a method for displaying the BIOS debug message. The method is able to enhance the function of the PC debug port display panel for adapting to the programming method, so as to cope with the limitations/disadvantages of the PC debug port displayed in the conventional BIOS. A more detailed debug message can be simultaneously displayed without having to modify the conventional PC debug port interface and while its convenience is also maintained. For example, it can display the error type code, detailed code, related figures such as fan speed, microprocessor temperature, operating voltage, it can distinguish the error status display from the normal information display (hi-lighting, flashing warning message), and it can also display an error message in Chinese/English.

To be noted, with the present invention, the designer of the mainboard and BIOS can achieve the object of displaying more versatile debug information, to help the user and developer locate reasons for malfunction, without having to modify the physical interface of the PC debug port on the chipset. More particularly, by using the present invention, the PC debug port interface, which before was only used for displaying a single error code, can display more versatile information. Therefore, besides displaying the debug message and related information during the BIOS power on self test, it further displays the general purpose information such as date and time during the normal operation period of the mainboard.

The present invention provides a method for displaying BIOS debug message. The method determines the display style of the character code after the character code and the attribute code are output by the BIOS via the debug port.

FIG. 2A schematically shows a basic structure diagram of the present invention. The apparatus for displaying BIOS debug message 220 comprises a controller 10 and a display panel 230. The present invention can be allocated inside a host electronic device such as a mainboard and an interface card. The debug message written by the debug port of the host electronic device is decoded and displayed in a versatile style. The object mentioned above is mainly achieved by using a controlling method of outputting an attribute code corresponding to a character code by the PC debug port. The present invention mainly comprises an input interface 222, a storage module 234, a decoding module 250, and an output interface 224. In order to achieve the display function that is compatible to the one in the prior art having no attribute information, a mode control unit 232 can be added for controlling the switching of the attribute decoding function.

Wherein, the input interface 222 electrically couples to a debug port of the host electronic device and sequentially receives a series of debug messages written by the debug port of the host electronic device, wherein the debug message comprises character codes and attribute codes. Each character code corresponds to an attribute code which is used to control the displaying effect (style) and decoding style of this character code. In some subsequent embodiments of the present invention, the debug message further comprises an address code for controlling the updated storage address of the corresponding character code or attribute code.

The storage module 234 electrically couples to the input interface 222 and the decoding module 250. It comprises a plurality of memory elements for storing the debug message input via the input interface. Moreover, the storage module 234 is divided into a first storage region 238 and a second storage region 240 according to the characteristic of the contents it stores. The memory elements in the first storage region 238 store the character codes, and the memory elements in the second storage region 240 store the attribute codes. Furthermore, the first storage region 238 contains m memory elements, and the second storage region 238 contains n memory elements.

The decoding module 250 electrically couples to the storage module 234 and the output interface 224. It also comprises a character decoder 226 and an attribute decoder 228 for decoding the character code and the attribute code stored in the storage module as the display information and the display style control signal, respectively. The attribute decoder further outputs a control signal to the character decoder for selecting a character decoding style.

The output interface 224 is electrically coupled to an external display panel 230 and is used to determine the information displaying style and effect according to the decoded display style control signal, and further generates a displaying electric signal output suitable for the external display panel 230.

In order to be backward compatible with display of the conventional debug code without attribute information, a mode control unit 232 can be added in the present invention. The mode control unit 232 assumes either of two possible states: an ON state or an OFF state. According to its current state, a mode control signal output is electrically coupled to the input interface 222, the storage module 234, and the decoding module 250. When the mode control unit 232 is in the ON state, the input interface 222, the storage module 234 and the decoding module 250 function as described herein. When the mode control unit 232 is in the OFF state, all debug messages in the storage module 234 are treated as character codes; further, the attribute decoder 228 inside the decoding module 250 constantly outputs a predetermined displaying style control signal to the output interface 224, and outputs a predetermined character decoding style selection control signal to the character decoder 226. The mode control unit 232 switches its state under control of a general purpose input/output (GPIO) port from the host electronic device. Alternatively, a predefined pattern of control code sequence via the input interface 222 can be used for state switch of the mode control unit 232.

FIG. 2B, accompanied with FIG. 2A, schematically shows a basic operation flow chart of the present invention. At first, in step S204, the debug message written by the PC debug port is input from the input interface 222. Then, in step S206, if the mode control signal is ON as determined by current state of the mode control unit 232, the storage module interprets the debug message as a character code and an attribute code in step S208, and it is stored into the first storage region 238 and the second storage region 240 respectively in step S210 and S212. Then, since the mode control signal in step S214 is still ON, step S216 is subsequently performed, in which the attribute decoder 228 in the decoding module decodes the attribute code of the second storage region 240 as a display control signal, and outputs a character decoding style selection control signal to the character decoder 226. In step S220, the character decoder 226 decodes the character code as display information according to the character decoding style selection control signal. Finally, in step S224, the output interface 224 outputs the decoded display information to the external display panel 230 according to the display control signal decoded in step S220. In step S206, if the mode control signal output by the mode control unit 232 is OFF, step S212 is subsequently performed, in which all debug messages stored in the storage module 234 are treated as the character codes and directly stored in the first storage region 238 without being interpreted. In step S214, since the mode control signal is OFF, step S218 is subsequently performed, in which the attribute decoder 228 of the decoding module constantly outputs a predetermined displaying style control signal to the output interface 224, and also outputs a predetermined character decoding style selection control signal to the character decoder. Then, in step S222, the character decoder 226 decodes the character code as the displaying information according to the predetermined character decoding style selection control signal. Finally, in step S226, the output interface 224 outputs the displaying information decoded from the character code to the external display panel 230 for displaying according to the predetermined displaying style control signal generated in step S218.

Further, since the storage module 234 of the present invention comprises a limited number of plural memory elements, more than one debug message can be displayed simultaneously (versus only displaying one single debug message in the prior art). However, accompanying the debug messages continuously input, the content of the storage module needs to be gradually updated for updating the debug information it displays. The memory elements in the storage module 234 can be organized with various structure styles, so as to achieve the object of gradually updating the debug message it displays, wherein the various structure styles are such as:

1. The first storage region 238 and the second storage region 240 are combined as a single FIFO storage structure.

2. Each of the first storage region 238 and the second storage region 240 is an independent FIFO storage structure.

3. The first storage region 238 and the second storage region 240 are address random access storage structures, wherein each memory element has one specific address, and the address is used for controlling the random write in.

Adapting to various storage structures, the host electronic device transmits the debug message via the debug port in various styles, wherein the character code and the attribute code are transmitted in a sequence corresponded with each other. The various styles are such as:

1. The character code and the attribute code are continuously transmitted in segments of:

(the 1^{st} set of attribute code, the 2^{nd} set of attribute code, . . . , the n^{th} set of attribute code), (the 1^{st} set of character code, the 2^{nd} set of character code, . . . , the m^{th} set of character code), wherein the segment length N, M is the number of the memory elements in the first and second storage regions, respectively.

For adapting to the storage structure that combines the first storage region 238 and the second storage region 240 as a single FIFO storage structure, the storage module 234 purely sequentially writes data into the single FIFO storage structure record by record without having to inspect it when the debug message is received from the input interface 222.

2. The character code and the attribute code are alternately transmitted as:

(the 1^{st} set of character code, the 1^{st} set of attribute code), (the 2^{nd} set of character code, the 2^{nd} set of attribute code).

The storage module interprets the debug message as the character code and the attribute code and alternately stores it to the FIFO storage structure of the first storage region 238 and the second storage region 240 respectively after the debug message is received from the input interface 222.

3. The debug message further comprises the address code for controlling the displaying update, and it is alternately transmitted accompanying the corresponding character code or the attribute code as:

(the 1^{st} set of address control code, the 1^{st} set of character code or the 1^{st} set of attribute code), (the 2^{nd} set of address control code, the 2^{nd} set of character code or the 2^{nd} set of attribute code).

After the debug message is received from the input interface 222, the storage module 234 first decomposes the debug message into address code and its accompanying character code or attribute code, and then writes the character code or the attribute code into the random access storage structure that is composed of the first storage region 238 and the second storage region 240 according to the corresponding address code.

As described earlier, in the storage module 234 of the present invention, the memory elements can be configured as different storage structures for adapting to different transmission sequence styles, so as to achieve the object of controlling the displaying update. If the single FIFO storage structure composed of the first storage region 238 and the second storage region 240 is used for adapting to the continuous segments transmission method, the storage module 234 only has to sequentially write the debug message (1). In other embodiments, the debug message from the input interface is further decomposed into character code and attribute code, or furthermore, address code. Then, the decomposed message is then stored in the corresponding storage structure with a storage control style of either (2) alternate writing in or (3) random writing in. Therefore, a storage control interface unit 236 can be further included in the storage module 234 of the basic structure. The storage control interface 236 is used to implement various debug message decomposing and storage controlling styles.

In summary, the storage module 234 has various implementation styles and related corresponding methods, such as:

1. The first storage region 238 and the second storage region 240 are combined as a single FIFO storage structure. The character codes and the attribute codes are sequentially written by using segment transmission, and the special storage control interface unit 236 is not needed for it.

2. Each of the first storage region 238 and the second storage region 240 is an independent FIFO storage structure. A storage control interface unit 236 decomposes debug message received into the character codes and the attribute codes and then writes them into the corresponding storage regions.

3. The first storage region 238 and the second storage region 240 are random access storage structures. A storage control interface unit 236 decomposes debug message received into the address codes and the accompanying character codes or the attribute codes that are transmitted alternately, and the latter is randomly written into the corresponding address.

Detailed implementation information for the storage control interface 236 is described hereinafter referring to the proposed preferred embodiments.

The attribute decoder of the present invention can be embodied in different styles, such as:

1. A multi-attribute-bit decoder, that is the displaying method using a multi-attribute-bit to control the corresponding character code;

2. A comparator, i.e. using the method of comparing whether the character code is equal to the corresponding attribute code to control the display of the character code.

To be noted, in different kinds of storage structures of the storage module mentioned above, although the number of the memory elements in the first storage region(M) is the same as the number of the memory elements in the second storage region(N) in most common cases, M is not necessarily equal to N. For example, M>1 and N=1, using a single attribute code to control the displaying style (effect) and the decoding style of all character codes. Further, the bit number contained in each character code is not necessarily the same as the bit number contained in each attribute code. For example, in displaying the double-byte Chinese character code, the 8 bits attribute code is used to control the displaying effect of the 16 bits Chinese character code. Only when the comparator is used for implementing the attribute decoder, does the character code have to map to the attribute code one by one, and herein the number of the memory elements in these two storage regions must be equal and the bit number contained in each memory element must all be equal too.

It is known from the description mentioned above, the individual components of the present invention, such as the storage module or the attribute decoder, can be implemented in different styles. However, it is to be noted that the description mentioned above and hereafter only exemplifies a few possible implementations for achieving the function of the present invention, and it will be apparent to one of the ordinary skill in the art that the present invention can be implemented with equivalent components and methods, and not to be limited by the examples shown in the present invention.

Moreover, these implementation styles with different components also can be integrated with each other as a specific embodiment for achieving the principle of the present invention. To be noted, the so-called preferred embodiment is exemplified herein with some possible combinations for easy explanation, and the present invention is not limited by it. No matter the various combinations, as long as they comply with the basic structure mentioned above (FIG. 2A), they are all within the scope of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1A schematically shows a block diagram of a conventional debug code displaying apparatus having no attribute;

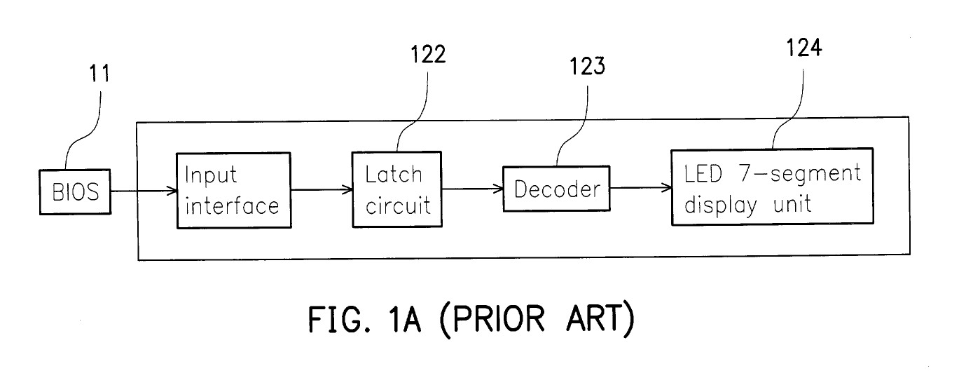

FIG. 1B is a flow chart of FIG. 1A;

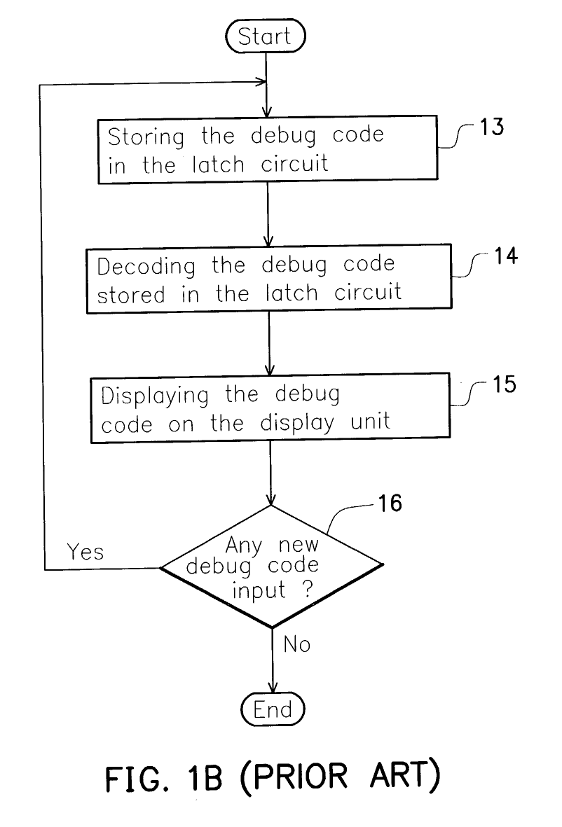

FIG. 2A schematically shows a basic structure diagram (functional block diagram) of the present invention;

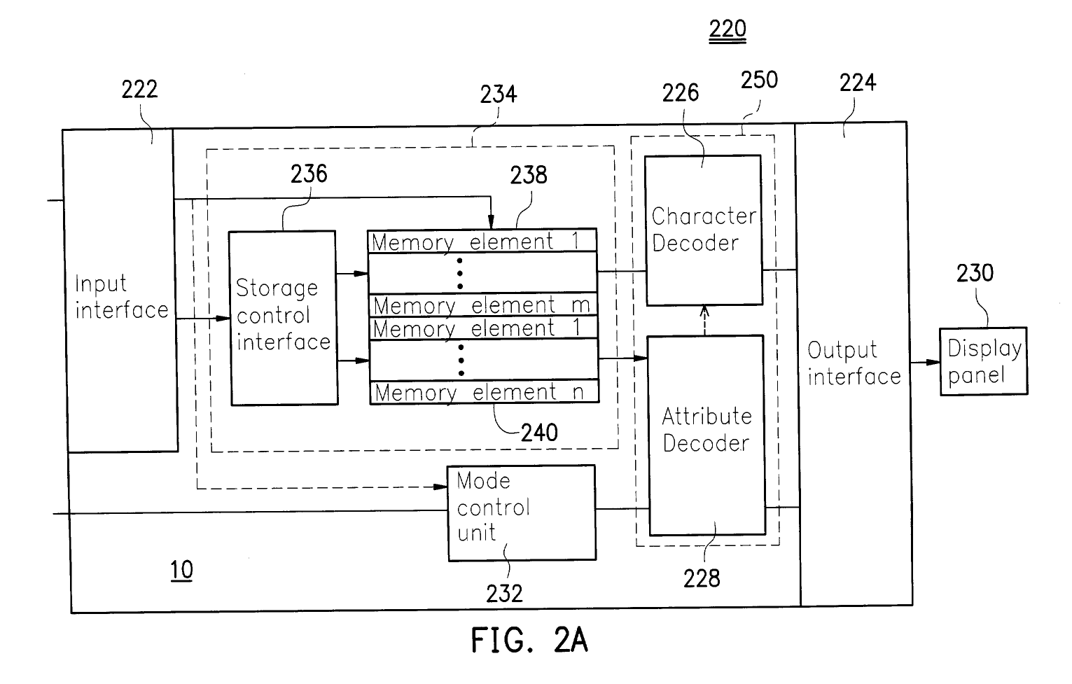

FIG. 2B is a flow chart of the basic structure (FIG. 2A) of the present invention;

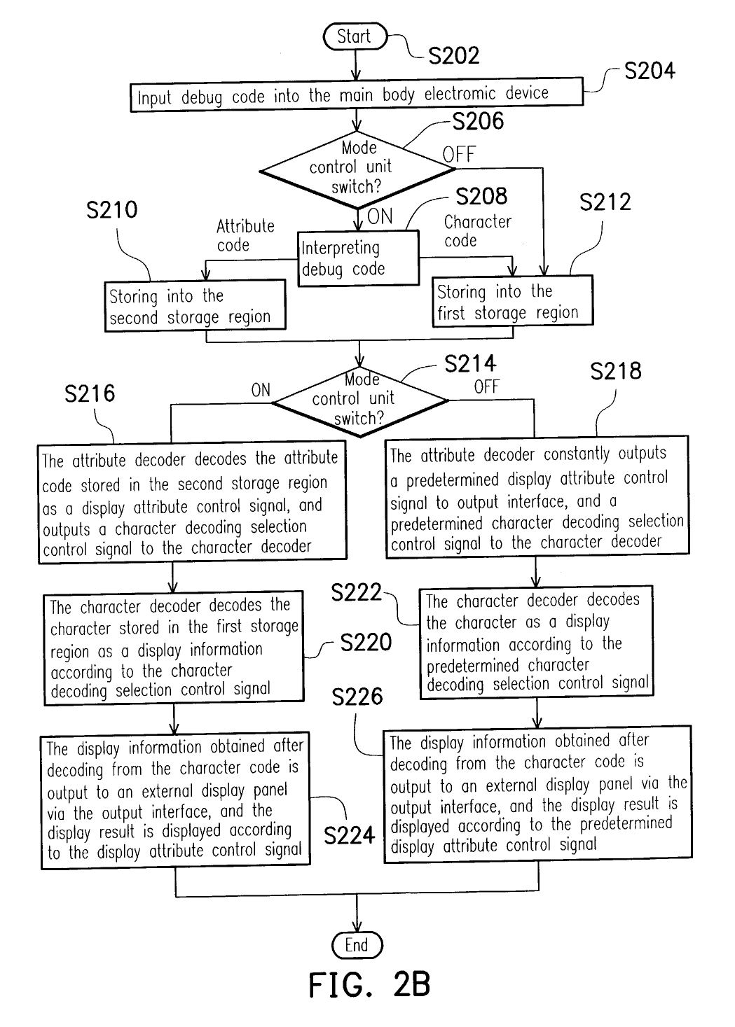

FIG. 3A schematically shows a block diagram of a preferred embodiment according to the present invention;

FIG. 3B schematically shows a sketch map of the multi-attribute-bit decoding in the embodiment of FIG. 3A;

FIG. 4 schematically shows a block diagram of another preferred embodiment according to the present invention; and

FIG. 5 schematically shows a block diagram of another preferred embodiment according to the present invention.

### DESCRIPTION OF THE PREFERRED EMBODIMENTS

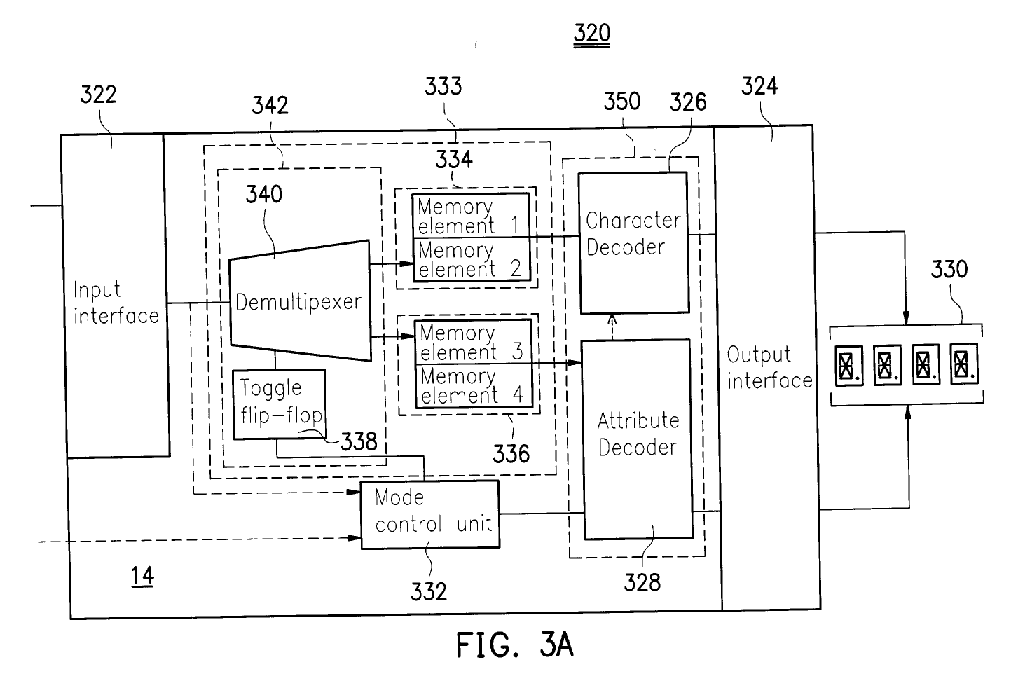

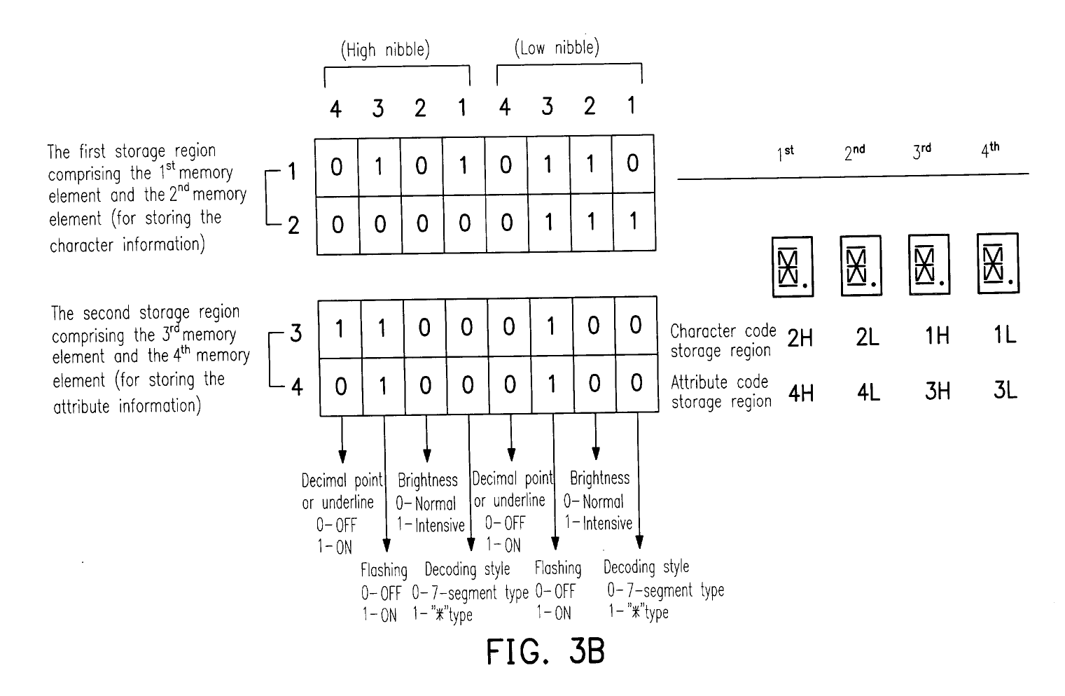

As shown in FIG. 3A, the apparatus for displaying BIOS debug message 320 comprises a controller 14 and a display panel 330. The controller 14 of the present invention mainly comprises an input interface 322, a storage module 333, a decoding module 350, an output interface 324, and a mode control unit 332. The input interface 322 electrically couples to a debug port of a host electronic device, the storage module 333, and the mode control unit 332, and sequentially receives a series of debug messages written via the debug port. The debug message comprises the character codes and the attribute codes that are transmitted to the storage module 333 in an alternately sequential style.

The storage module 333 electrically couples to the decoding module 350 and comprises a storage control interface 342, a first storage region 334 and a second storage region 336. Each of the first storage region 334 and the second storage region 336 is an independent FIFO shift storage structure that comprises a plurality of memory elements. The storage control interface 342 comprises a demultiplexer 340 and a toggle filp-flop 338. The demultiplexer 340 couples to the toggle flip-flop 338, the first storage region 334, and the second storage region 336. Each time when the input interface 322 receives a component of the debug message, the toggle flip-flop 338 inverts its output that servers as a control signal to the demultiplexer 340, and the demultiplexer 340 thus decomposes the input debug message as (the 1^{st} set of character code, the 1^{st} set of attribute code), (the 2^{nd} set of character code, the 2^{nd} set of attribute code), . . . according to the toggle flip-flop's status, so that the character code and the attribute code can be alternately stored into the first storage region 334 and the second storage region 336, respectively. Further, the toggle flip-flop 338 electrically couples to the mode control unit 332. Each time when the state of the mode control unit 332 is changed, the toggle flip-flop 338 will be reset, to re-synchronize the controller 14 with the BIOS of the host electronic device for proper de-multiplexing and interpretation of the debug message.

The decoding module 350 electrically couples to the output interface 324 and comprises a character decoder 326 and an attribute decoder 328. The decoding module 350 decodes the received character code and the attribute code as the displaying information and the displaying style control signal, respectively. The attribute decoder 328 further electrically couples to the character decoder 326. It decodes the attribute code and generates a character decoding style selection control signal and outputs it to the character decoder 326, so as to determine the decoding style of the corresponding character code. The character decoder 326 decodes the character code according to the character decoding style selection control signal.

The output interface 324 couples to an external display panel 330, and determines the displaying style and effect for displaying information according to the decoded displaying control signal, and further generates a displaying electrical signal output that is compatible to the display panel 330.

In order to have it back compatible with the conventional debug code displaying function having no attribute, a mode control unit 332 is used in the present embodiment for turning on or off the attribute decoding function. The mode control unit 332 outputs a mode control signal according to its current state. The mode control signal feeds to the storage module 333 and the attribute decoder 328. As long as the mode control unit is in the OFF state, the toggle flip-flop 338 continuously stays on a reset state, and the selection control of the demultiplexer 340 is fixed. Therefore, all debug messages written into the storage module 333 are treated as the character codes. Meanwhile, the attribute decoder 328 constantly outputs a predetermined displaying style control signal to the output interface 324, and outputs a predetermined character decoding style selection control signal to the character decoder 326. The state of mode control unit can be switched under control of a GPIO port of the host electronic device. Alternatively, a predefined pattern of control code sequence via the input interface 322 can be used for state switch of the mode control unit 332.

In the present embodiment, the attribute decoder 328 is embodied by using a multi-bit-attribute controlling method, another drawing is used hereinafter for further describing the method for controlling the displaying effect with the multi-bit-attribute. FIG. 3B schematically shows a sketch map of the bit attribute control. Since the most common bit length of the individual character code and the attribute code contained in the general debug message is 8 bits, the capacity of each memory element in the storage module is 8 bits in the present embodiment, and each of the first storage region and the second storage region contains 2 memory elements. However, the present invention is not limited to such an implementation, and the first and second storage regions can be another storage capacity. The first storage region comprises a 1^{st} and a 2^{nd} memory element, and the stored character code. The second storage region comprises the 3^{rd} and the 4^{th} memory element, and the stored attribute code. Each memory element comprises two nibbles, i.e. a high nibble and a low nibble. The attribute code of the low nibble of the 3^{rd} memory element corresponds to the character code of the low nibble of the 1^{st} memory element, so as to determine the displaying effect of the 4^{th} displaying number (the most right hand side) on the display panel. The attribute code of the high nibble of the 3^{rd} memory element corresponds to the character code of the high nibble of the 1^{st} memory element, so as to determine the displaying effect of the 3^{rd} displaying number on the display panel. The attribute code of the low nibble of the 4^{th} memory element corresponds to the character code of the low nibble of the 2^{nd} memory element, so as to determine the displaying effect of the 2nd displaying number on the display panel. The attribute code of the high nibble of the 4^{th} memory element corresponds to the character code of the high nibble of the 2^{nd} memory element, so as to determine the displaying effect of the 1^{st} displaying number on the display panel.

In the second storage region, each nibble comprises 4 bits, and each bit determines a displaying style or character decoding style. In the present embodiment, the 1st bit is a displaying control for decimal point or underline (1 for ON, 0 for OFF); the 2^{nd} bit is a displaying control for flashing (1 for ON, 0 for OFF); the 3^{rd} bit is a displaying control for brightness effect (1 for intensive brightness, 0 for normal brightness); the 4^{th} bit is a selecting control for the decoding style (1 for “ [symbol] ” type decoding, 0 for 7-segment decoding). Each record of the character code is decoded by using a specified decoding style and displaying effect and also thus displayed on the display panel according to a record of the attribute code corresponded to it. In the embodiment of the present invention, the capacity of storage module, the size of each memory element and the number of the attribute controlling bits are based on the requirements of the message width, character coding, and attributes to be displayed. The attribute code corresponding to each=character code is not limited to be 4 bits, and the memory element is not limited to be 4 bits or 8 bits, either. In the present embodiment, the external display panel is a 7-segment display, but there are other types of implementations. The decoding style of the character code can be a BCD (4 bits), a “ [symbol] ” type (6 bits), an English ASCII (8 bits), and an Unicode (16 bits), or others of the like.

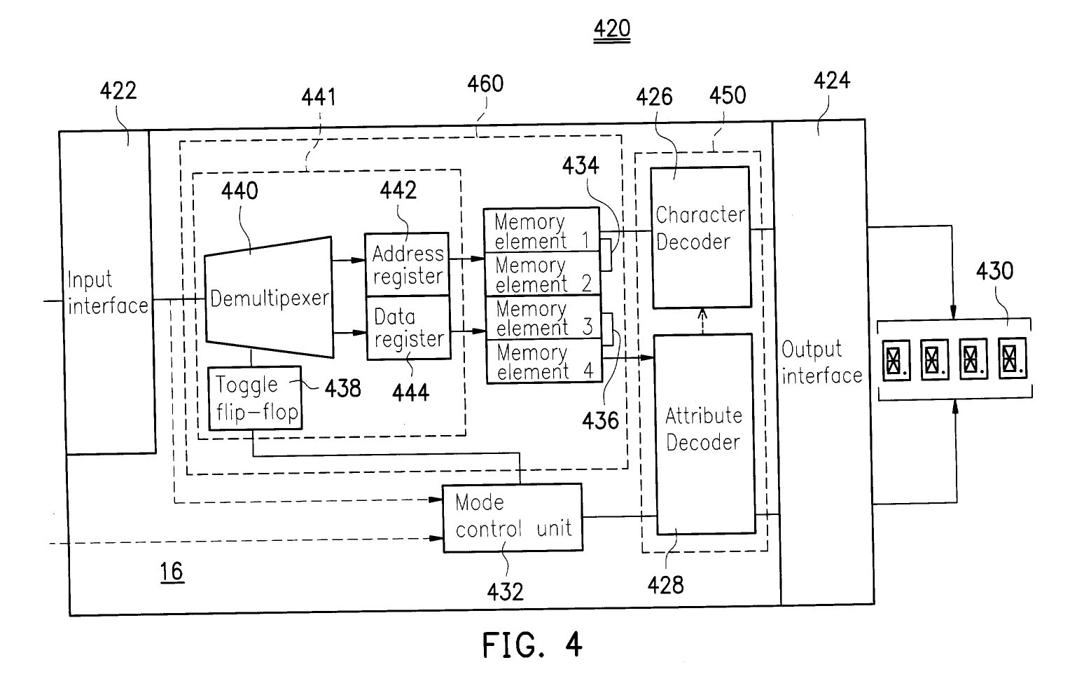

FIG. 4 schematically shows another embodiment of the present invention. The apparatus for displaying BIOS debug message 420 comprises a controller 16 and a display panel 430. The difference from the previous embodiment is the structure of the storage module. In the present embodiment, the writing and interpreting of the debug message is implemented in an address-controlled style. Only the different portion from the previous embodiment is described, other portions are not described herein again.

In the present embodiment, the memory elements of the first storage region 434 and the second storage region 436 inside the storage module 460 constitute an address-controlled random access storage structure. The debug message input from the input interface 422 comprises an address code and an accompanying character code or attribute code. After accepting the debug information from the input interface 422, the storage module 460 first isolates the address code from the accompanying character code or the accompanying attribute code, and then stores the character code or the attribute code into the memory element within the storage region as specified by the its corresponding address code.

The storage control interface 441 of the present embodiment comprises a toggle flip-flop 438, a demultiplexer 440, an address register 442, and a data register 444. The toggle flip-flop 438 electrically couples to the input interface 422, the demultiplexer 440, and the mode control unit 432. The demultiplexer 440 couples to the address register 442 and the data register 444. The address register 442 and the data register 444 further couple to the first storage region 434 and the second storage region 436.

The input interface 422 sequentially transmits a series of the debug messages to the storage module 460. After reception of each component, such as address code, character code and attribute code, of the debug messages, the toggle flip-flop 438 inverts its output that controls the demultiplexer 440. The demultiplexer 440 then divides streams of the debug messages that are continuously input as (the 1^{st} set of address controlling code, the 1^{st} set of character code or the 1^{st} set of attribute code), (the 2^{nd} set of address controlling code, the 2^{nd} set of character code or the 2^{nd} set of attribute code), according to the toggle status, so as to alternately store them into the address register 442 and the data register 444. The accompanying character code or the attribute code in the data register 444 is then stored into a specific memory element according to the address controlling code of the address register 442. The other portions are the same as the embodiment of FIG. 3A and FIG. 3B, therefore it is not described herein again.

It is noted that a random access storage control is used by the storage module 460 of the present embodiment, so that the BIOS of the host electronic device becomes more easily used for optionally updating partial debug information displaying content or effects, not like the FIFO storage structure used by other embodiments, where it is needed to resend all character codes and attribute codes again even in the case where only partial debug messages for displaying are to be modified. However, compared to the FIFO structure, the circuit of the random access storage structure is more complicated, and the debug message also needs an extra address controlling code. Moreover, its corresponding storage control interface 441 is more complicated, too.

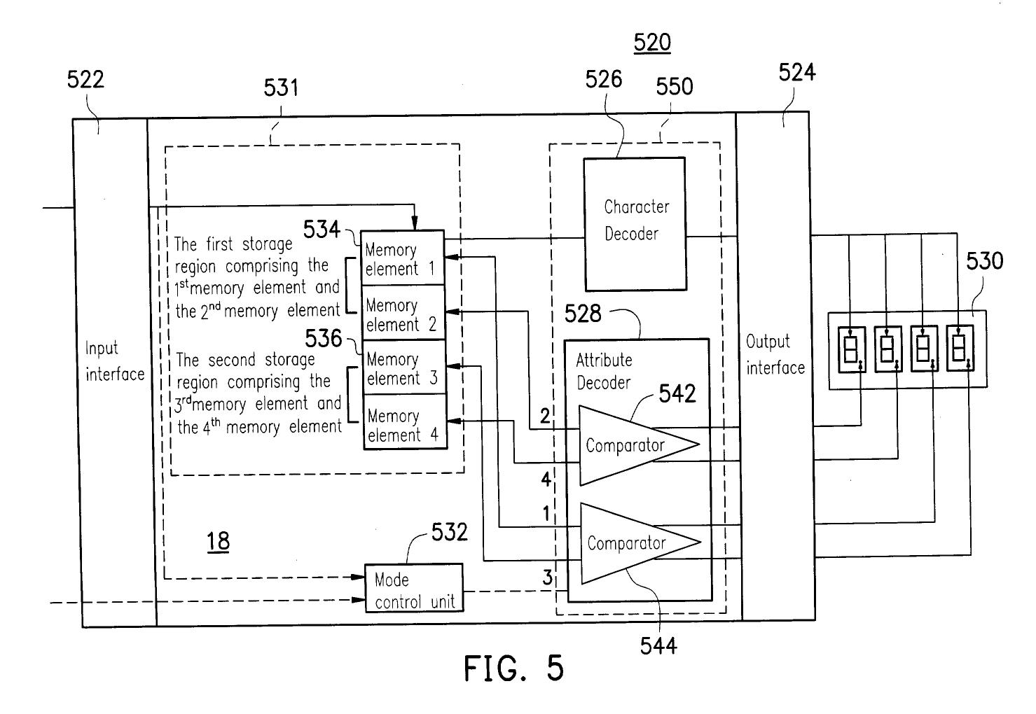

FIG. 5 schematically shows another preferred embodiment of the present invention, wherein the apparatus for displaying BIOS debug message 520 comprises a controller 18 and a display panel 530. In the present embodiment, the structure of the storage module 531 is different from the ones in those two embodiments mentioned above. The input interface 522 receives the debug messages written by a host electronic device, wherein a series of the debug messages are stored into the first storage region 534 and the second storage region 536 record by record with a continuous segment format of (the 1^{st} attribute code, the 2^{nd} attribute code, . . . , the N^{th} attribute code), (the 1^{st} character code, the 2^{nd} character code, . . . , the M^{th} character code). In the present embodiment, the first storage region 534 and the second storage region 536 are combined as a single FIFO shift storage structure. The debug messages received from the input interface 522, i.e. a series of continuous attribute codes plus a series of its corresponding continuous character codes, are directly stored into the memory elements record by record in a manner of being sequentially pushed into the memory element starting from the first address memory element of the first storage region 534 in a first in first out (FIFO) sequence. The next coming component of debug message is pushed into the first address memory element of the first storage region 534, and the content originally stored in the first memory element is shifted to the memory element of next address. The content of the memory element of last address in the first storage region 534 is then pushed into the first address memory element of the second storage region 536, and the content of the memory element of the last address in the second storage region 536 is pushed out and abandoned. Moreover, each character code of the first storage region 534 corresponds to an attribute code of the second storage region 536. To be noted, using a storage control interface to control the decomposition of debug message in the embodiment mentioned above is not mandatory in the storage module 531 of the present embodiment when writing in the debug messages. Therefore, it is advantageous in its low implementation cost. Furthermore, the difference from the two previous embodiments is that a comparator is used to implement the attribute decoder in the present embodiment. The attribute decoder 528 compares the character code with its corresponding attribute code, and if they are the same, a predetermined displaying control signal such as decimal point, underline, flashing, or intensive brightness displaying effect is generated.

In the present embodiment, the low nibble of the 1^{st} memory element is compared with the data of the low nibble of the 3^{rd} memory element, and if they are the same, the decimal point on the right bottom of the 4^{th} displaying character is shining. If the high nibble of the 1st memory element is equal to the information content of the high nibble of the 3^{rd} memory element, the decimal point on the right bottom of the 3^{rd} displaying character is shining. If the low nibble of the 2^{nd} memory element is equal to the information content of the low nibble of the 4^{th} memory element, the decimal point on the right bottom of the 2^{nd} displaying character is shining. If the high nibble of the 2^{nd} memory element is equal to the information content of the high nibble of the 4^{th} memory element, the decimal point on the right bottom of the 1^{st} displaying character is shining. The present embodiment uses the comparator to implement the attribute decoding, although it can only display fewer number of displaying effects compared with the multi-bit-attribute decoder in the previous embodiment, it is advantageous in its low cost economic advantage.

Although the invention has been described with reference to a particular embodiment thereof, it will be apparent to one of the ordinary skill in the art that modifications to the described embodiments may be made without departing from the spirit of the invention. Accordingly, the scope of the invention will be defined by the attached claims not by the above detailed description.

What is claimed is:

1. A method for displaying BIOS debug message, comprising:
outputting a character code and an attribute code by the BIOS via a debug port; and
determining a displaying style according to the attribute code.

2. The method for displaying BIOS debug message of claim 1, wherein the bit number contained in the character code is equal to the bit number contained in the attribute code.

3. The method for displaying BIOS debug message of claim 2, wherein when the attribute code is equal to the character code, a decimal point is displayed on a displaying position of the character code.

4. The method for displaying BIOS debug message of claim 1, wherein the attribute code comprises a plurality of bits, and each of the plurality of bits controls a displaying style.

5. The method for displaying BIOS debug message of claim 1, wherein the displaying style comprises at least one item among the flashing, underline, decimal point, and intensive brightness.

6. The method for displaying BIOS debug message of claim 1, wherein the attribute code is further used to determine a decoding style of the character code.

7. The method for displaying BIOS debug message of claim 6, wherein the decoding style of the character code comprises one style among the binary encoded number decoding, “ [symbol] ” type decoding, character/numeric switching, and Chinese/English switching.

8. The method for displaying BIOS debug message of claim 1, wherein the BIOS alternately outputs the attribute code and the character code.

9. The method for displaying BIOS debug message of claim 1, further comprising:
using a mode control signal to determine whether or not the displaying style of the character code is to be decided by the attribute code.

10. The method for displaying BIOS debug message of claim 9, wherein
the mode control signal is further settable by a predefined pattern of control code sequence

11. The method for displaying BIOS debug message of claim 9, further comprising:
activating the mechanism that the attribute code decides the displaying style of the character code when the mode control signal is ON; and
otherwise, instead of the attribute code, a predetermined displaying style control signal deciding the displaying style of the character code.

12. The method for displaying BIOS debug message of claim 1, further comprising:
receiving an address signal; and
determining a storage location for storing the attribute code and the character code according to the address signal.

13. A controller for controlling the BIOS debug message displaying, comprising:
an input interface, used to receive an attribute code and a character code transmitted from a debug port of the BIOS;
a decoding module, used to decode the attribute code and the character code so as to output a corresponding displaying control signal and a displaying information; and
an output interface, used to output the displaying information in a displaying style based on the displaying control signal.

14. The controller for controlling the BIOS debug message displaying of claim 13, further comprising a storage module connected in between the input interface and the decoding module, so as to store the attribute code and the character code.

15. The controller for controlling the BIOS debug message displaying of claim 14, wherein the storage module comprises:
a first storage region, used to store the attribute code; and
a second storage region, used to store the character code.

16. The controller for controlling the BIOS debug message displaying of claim 14, wherein the storage module further comprises a storage control interface, and the storage control interface electrically couples in between the input interface and the storage module, and used to control the deposit of the received attribute code and character code.

17. The controller for controlling the BIOS debug message displaying of claim 16, wherein the storage control interface comprises a demultiplexer, and the demultiplexer decomposes the debug message into the attribute code and the character code according to a control signal.

18. The controller for controlling the BIOS debug message displaying of claim 17, wherein the storage control interface further comprises a toggle flip-flop, and the toggle flip-flop changes the control signal to the demultiplexer while the debug message is received from the input interface.

19. The controller for controlling the BIOS debug message displaying of claim 17, wherein the storage control interface comprises:
an address register, used to cache an address code; and
a data register, used to cache the attribute code and the character code, and to store the attribute code and the character code into the storage module specified by the address code.

20. The controller for controlling the BIOS debug message displaying of claim 13, wherein the decoding module comprises:
an attribute decoding module, used to decode the attribute code; and
a character decoding module, used to decode the character code.

21. The controller for controlling the BIOS debug message displaying of claim 20, wherein the attribute decoding module further outputs a character decoding style selecting signal to the character decoding module after the attribute code is decoded, so as to control a decoding style that is selected and used while the character code is being decoded by the character decoding module.

22. The controller for controlling the BIOS debug message displaying of claim 13, further comprising a mode control unit, and the mode control unit outputs a mode control signal to determine whether or not to base the displaying style on the displaying control signal.

23. The controller for controlling the BIOS debug message displaying of claim 22, wherein the state of the mode control unit is further controlled by a general purpose input/output (GPIO) port or by a predefined pattern of control sequence from the input interface.

24. The controller for controlling the BIOS debug message displaying of claim 22, further comprising a storage module connected in between the input interface and the decoding module, so as to store the attribute code and the character code.

25. The controller for controlling the BIOS debug message displaying of claim 24, wherein the mode control unit further electrically couples to a storage control interface inside the storage module and the decoding module,
wherein the storage control interface electrically couples in between the input interface and the storage module so to control the deposit of the received attribute code and character code,
and with the mode control signal being toggled, the storage control interface is reset to resynchronize the debug message sequence with the host electronics;
wherein, when the mode control signal is OFF, the storage control interface is kept under reset to treat all the debug messages as the character codes, and a predetermined displaying style control signal is used to control the displaying style of the character codes.

26. An apparatus for displaying BIOS debug messages, comprising:
a controller, used to receive an attribute code and a character code transmitted from a debug port of the BIOS, and to control a displaying style of the character code according to the attribute code; and
a display panel, used to display the character code with the displaying style determined by the controller.

27. The apparatus for displaying BIOS debug messages of claim 26, wherein the controller comprises:
an input interface, used to receive the attribute code and the character code transmitted from the debug port;
a decoding module, used to decode the attribute code and the character code, so as to output a corresponding displaying control signal and a displaying information; and
an output interface, used to output the displaying information in a displaying style based on the displaying control signal.

28. The apparatus for displaying BIOS debug messages of claim 27, further comprising a storage module for storing the attribute code and the character code.

29. The apparatus for displaying BIOS debug messages of claim 28, wherein the storage module further comprises a storage control interface, and the storage control interface electrically couples in between the input interface and the storage module, and is used to control the deposit of the received attribute code and character code.

30. The apparatus for displaying BIOS debug messages of claim 29, wherein the storage control interface comprises a demultiplexer, and the demultiplexer decomposes the attribute code and the character code according to a control signal.

31. The apparatus for displaying BIOS debug messages of claim 29, wherein the storage control interface comprises:
an address register, used to cache an address code; and
a data register, used to cache the attribute code and the character code, and to store the attribute code and the character code into the storage module according to the address code in the address register.

32. The apparatus for displaying BIOS debug messages of claim 27, wherein the decoding module comprises:
an attribute decoding module, used to decode the attribute code; and
a character decoding module, used to decode the character code.

33. The apparatus for displaying BIOS debug messages of claim 27, further comprising a mode control unit, and the mode control unit outputs a mode control signal to determine whether or not to base the displaying style on the displaying control signal.
